(19) United States
(12) Patent Application Publication
(10) Pub. No.: US 2018/0300337 A1
(43) Pub. Date: Oct. 18, 2018

(54) METHOD AND SYSTEM FOR MANAGING VIRTUAL ASSISTANTS

(71) Applicant: Brillio LLC, Edison, NJ (US)

(72) Inventors: Renji Kuruvilla Thomas, Bangalore (IN); Arun Kumar Vijaya Kumar, Bangalore (IN); Jinu Isaac Kuruvilla, Bangalore (IN); Karthik Gopalakrishnan Vinmani, Bangalore (IN)

(21) Appl. No.: 15/816,970

(22) Filed: Nov. 17, 2017

(30) Foreign Application Priority Data
Apr. 13, 2017 (IN) 201741013340

(51) Int. Cl. G06F 17/30; G06F 9/44

(52) U.S. Cl. CPC G06F 17/3053; G06F 9/4446

(57) ABSTRACT

Embodiments herein provide a method for managing virtual assistants. The method includes determining by a qualification management engine, the ability parameters associated with a plurality of VAs. Further, the method includes determining by the qualification management engine, a qualification level for each of the VAs based on the ability parameters associated with each of the VAs, where the qualification level indicates an ability of the VA to meet a user requirement. Furthermore, the method includes recommending by the qualification management engine, at least one VA from the plurality the VAs based on the qualification level associated with each of VAs.

### TECHNICAL FIELD

The embodiments herein generally relate to virtual assistants. More particularly related to a method and system for managing the virtual assistants. The present application is based on, and claims priority from an Indian Application Number 201741013340 filed on 13 Apr. 2017, the disclosure of which is hereby incorporated by reference.

### BACKGROUND

In general, virtual assistants (VAs), also known as automated online assistants, are systems that use artificial intelligence to provide a dialog with a user in order to respond to user queries. For example, companies often make use of virtual assistants to provide a form of customer interface, allowing many types of customer queries to be resolved without human intervention.

The virtual assistants have their own capabilities, limitations and platforms. If an advertiser needs to select a virtual assistant platform to place advertisements, the advertiser needs to be aware of the capabilities and limitations of the same. More importantly, the advertiser needs to know the abilities of the virtual assistants before placing advertisements. In the current scenario of electronic marketing, the advertisers select a virtual assistant to place advertisements without knowing the abilities and limitations of the virtual assistant. For example, an advertiser may place an advertisement on the virtual assistant which does not support a multi-linguistic ability as a result users may not be able to see the advertisement due to inability of the virtual assistant to support the language of the advertisement. Thus, neither advertisers nor users are benefited by placing the advertisement, on the virtual assistant which is not accessible or readable by the users.

In the conventional methods and systems, the user in a client device provide queries to a system which includes a plurality of virtual assistants. The system analyzes the queries and send the queries to the plurality of virtual assistants for generating answers. Further, the system generates a score for each answers provided by each of the virtual assistants based on a level of expertise in the given topics of the virtual assistants. Further, in some conventional methods and systems, the system generates the score for each answers based on historical results obtained by a machine learning of the plurality of virtual assistants.

The above conventional method and system generate scores only for the answers (successive rates) provided by the plurality of virtual assistants. However, there exists no system in which the virtual assistants are selected based on their capabilities, thereof, required to meet the user requirement thereto, which can strengthen the user interaction experience with the virtual assistants.

Therefore, there is a need to enable advertisers or agencies in choosing the appropriate virtual assistant to place the advertisements based on their needs.

### SUMMARY

Accordingly, the embodiments herein provide a method for managing the virtual assistants. The method includes determining by a qualification management engine, the ability parameters associated with a plurality of VAs. Further, the method includes determining by the qualification management engine, a qualification level for each of the VAs based on the ability parameters associated with each of the VAs, where the qualification level indicates an ability of the VA to meet a user requirement. Furthermore, the method includes recommending by the qualification management engine, at least one VA from the plurality the VAs based on the qualification level associated with each of VAs.

In an embodiment, the ability parameters include a number of clear user request received at the VA, a number of unclear user requests received at the VA, a pre-emptive ability of the VA to pre-empt a user request, a type of the VA and a linguistic ability of the VA.

In an embodiment, the pre-emptive ability of the VA to pre-empt the user request is determined by determining a type of the VA, detecting whether the VA is one of a single-purpose application and a multi-purpose application based the type of the VA and determining the VA ability to pre-empt the user request based on one of the single-purpose application and the multi-purpose application.

In an embodiment, each of the ability parameters is associated with a weight dynamically determined based on at least one of user preferences and user expectations from the VA.

In an embodiment, the qualification management engine determines a qualification level for each of the VAs based on the ability parameters associated with each of the VAs includes: determining an qualification index for each of the VAs based on the ability parameters associated with each of the VAs, where the ability parameters are dynamically determined based on a user interaction with the VAs in real-time, detecting whether the qualification index meets at least one qualification criteria, where the qualification criteria defines a qualification level indicating an ability of a VA to meet a user requirement and assigning the qualification level corresponding to the qualification criteria.

In an embodiment, the qualification management engine recommends the at least one VA from the plurality the VAs based on the qualification level associated with each of VAs includes: receiving by the qualification management engine a requirement of a user, dynamically determining by the qualification management engine the at least one VA from a plurality of VAs that meets the requirements of the user based on the qualification level associated with each of the VAs and recommending by the qualification management engine the at least one VA to the user, where the at least one recommended VA is ranked based on the qualification level.

Accordingly, embodiments herein provide a method for managing the virtual assistants. The method includes receiving by a qualification management engine a requirement of a user. Further, the method includes dynamically determining by the qualification management engine at least one VA from a plurality of VAs that meets the requirement of the user based on a qualification level associated with each of the VAs, where the qualification level is dynamically determined based on ability parameters and a weight associated with each of the ability parameters. Furthermore, the method includes recommending by the qualification management engine the at least one VA to the user.

In an embodiment, the qualification level indicates the ability of the VA to influence the user.

In an embodiment, the qualification level for each of the virtual applications is dynamically determined by determining by the qualification management engine a plurality of parameters associated with each of the VAs. Further, the method includes determining an qualification index for each of the VAs based on the ability parameters associated with each of the VAs, where the ability parameters are dynamically determined based on a user interaction with the VAs in real-time and detecting whether the qualification index meets at least one qualification criteria, where the qualification criteria defines a qualification level indicating an ability of a VA to meet a user requirement and assigning the qualification level corresponding to the qualification criteria.

Accordingly, the embodiments herein provide an electronic device for managing the virtual assistants. The electronic device includes a display controller, a memory to store a plurality of VAs, a processor and a qualification management engine operably coupled to the processor and the memory configured to: determine the ability parameters associated with a plurality of VAs, determine a qualification level for each of the VAs based on the ability parameters associated with each of the VAs, where the qualification level indicates an ability of the VA to meet a user requirement and recommend at least one VA from the plurality of the VAs based on the qualification level associated with each of VAs.

Accordingly, the embodiments herein provide an electronic device for managing the virtual assistants. The electronic device includes a display controller, a memory to store a plurality of VAs, a processor and a qualification management engine operably coupled to the processor and the memory configured to: receive a requirement of a user, dynamically determine at least one VA from a plurality of VAs that meets the requirement of the user based on an qualification level associated with each of the VAs, where the qualification level is dynamically determined based on ability parameters and a weight associated with each of the ability parameters, and recommend the at least one virtual assistant to the user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

This method is illustrated in the accompanying drawings, throughout which like reference letters indicate corresponding parts in the various figures. The embodiments herein will be better understood from the following description with reference to the drawings, in which:

FIG. 1 is a block diagram illustrating various hardware components of an electronic device, according to an embodiment as disclosed herein;

FIG. 2 is a block diagram illustrating various hardware components of a qualification management engine, according to an embodiment as disclosed herein;

FIGS. 3A-3D is a flow chart illustrating a method to determine ability parameters of a VA, according to an embodiment as disclosed herein;

FIG. 4 is a flow chart illustrating a method to determine a qualification level for the VA based on the ability parameters associated with the VA, according to an embodiment as disclosed herein;

FIG. 5 is a flow diagram illustrating a method to recommend the VA to a user based on the qualification level of the VA, according to an embodiment as disclosed herein; and

FIG. 6 is a flow diagram illustrating a method to recommend the VA to a user based on a requirement of the user, according to an embodiment as disclosed herein.

### DETAILED DESCRIPTION OF EMBODIMENTS

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments. Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Prior to describing the embodiments in detail, it is useful to provide definitions for key terms used herein. Unless defined otherwise, all technical terms used herein have the same meaning as commonly understood by a person having ordinary skill in the art to which this invention belongs.

Virtual assistant (VA): also referred as a virtual digital assistant, virtual intelligent assistant or chatbot. The VA can be an application running on a computing device, module, software running on a remote computing device etc. The VA enables a user/human to interact or communicate with a machine such as a computing device using natural language. The means for communication could be textual or speech. The VA take user inputs (speech/text) and interprets it. Further, the VA associates actions with user inputs and carry out those actions. In order to interpret the user inputs, the VA may use multiple sources of information such as social media, knowledge repositories, emails, user chat sessions, data of applications installed on user device etc. This is also needed to contextualize response to user inputs.

Accordingly, the embodiments herein provide a method for managing the virtual assistants. The method includes determining by a qualification management engine, the ability parameters associated with a plurality of VAs. Further, the method includes determining by the qualification management engine, a qualification level for each of the VAs based on the ability parameters associated with each of the VAs, where the qualification level indicates an ability of the VA to meet a user requirement. Furthermore, the method includes recommending by the qualification management engine, at least one VA from the plurality the VAs based on the qualification level associated with each of VAs.

Unlike to conventional methods and systems, the proposed method can be used to determine the capabilities of one or more VA based on the user requirement. Further, the proposed method can recommend one or more qualified VAs to the user, based on the capabilities determined to provide services for the user. Thus, improving a user experience by selecting one or more qualified VAs based on the user requirement.

Accordingly, the embodiments herein provide a method for managing the virtual assistants. The method includes receiving by a qualification management engine a requirement of a user. Further, the method includes dynamically determining by the qualification management engine at least one VA from a plurality of VAs that meets the requirement of the user based on a qualification level associated with each of the VAs, where the qualification level is dynamically determined based on ability parameters and a weight associated with each of the ability parameters. Furthermore, the method includes recommending by the qualification management engine the at least one VA to the user.

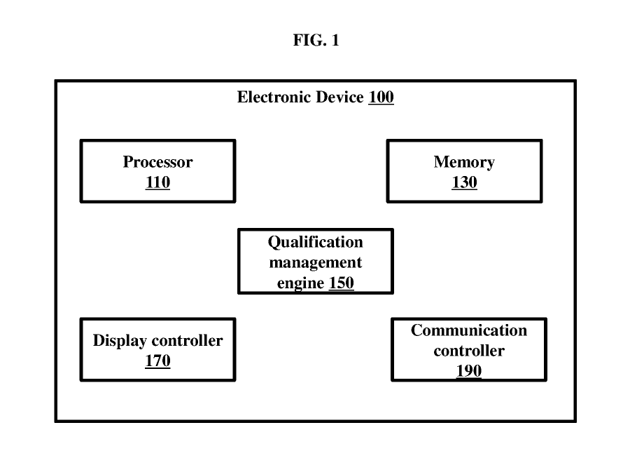

Referring now to the drawings, and more particularly to FIGS. 1 through 6, where similar reference characters denote corresponding features consistently throughout the figures, these are shown as preferred embodiments.

FIG. 1 is a block diagram illustrating various hardware components of an electronic device 100, according to an embodiment as disclosed herein;

The electronic device 100 can be, but not limited to a mobile phone, a smart phone, Personal Digital Assistants (PDAs), a tablet, a wearable device, a Head Mounted display (HMD) device, Virtual reality (VR) device, Augmented Reality (AR) devices, 3D glasses, display devices, Internet of things (IoT) devices, electronic circuit, chipset, and electrical circuit (i.e., System on Chip (SoC)), performs the proposed method. In another embodiment, the electronic device 100 can include, for e.g., a server, centralized computer, cloud network etc.

The electronic device 100 includes a processor 110, a memory 130, a qualification management engine 150, a display controller 170 and a communicator 190. The processor 110 is communicatively coupled to the memory 130 and the qualification management engine 150. The processor 110 can be, but not limited to a hardware unit, an apparatus, a Central Processing Unit (CPU), a Graphics Processing Unit (GPU)

The memory 130 includes storage locations to be addressable through the processor 110. The memory 130 are not limited to a volatile memory and/or a non-volatile memory. Further, the memory can include one or more computer-readable storage media. The memory 130 may include non-volatile storage elements. For example, non-volatile storage elements may include magnetic hard discs, optical discs, floppy discs, flash memories, or forms of electrically programmable memories (EPROM) or electrically erasable and programmable (EEPROM) memories. In some examples the memory 130 can be configured to store larger amount of applications (i.e. Virtual assistants) stored therein to provide one or more services to the user. Further, the memory 130 can be also configured to store the received user requirements from the user(s) for the future reference.

The qualification management engine 150 is coupled to the processor 110 and the display controller 170. Further, the qualification management engine 150 receives a request from the user, associated with a VA associated with the electronic device 100. The request can be, but not limited to a query, an advertisement, or any other notification. The VA can be, but not limited to a chat bot, a conversational agent, a virtual agent, an intelligent chat box, an artificial conversational entity, voice assistance apparatus, and the like. Further, the qualification management engine 150 determines the ability parameters (i.e., capabilities) of the VA. In an embodiment, the ability parameters can be, but not limited to a number of clear request received at the VA, a number of unclear request received at the VA, an ability to pre-empt the received request at the VA, a type of VA, linguistic ability of the VA and the like.

Further, the qualification management engine 150 determines a qualification index for the VA based on the ability parameters, where the ability parameters determined based on a user interaction with the VAs in real-time. In an embodiment, the qualification index can be but not limited to an appropriate response time of the VA to respond the user request, a sum of relevant answers provided by the VA to the user based on the user query, a number of iterations performed by the virtual assistant and the like. Furthermore, the qualification management engine 150 provides qualification level for the VA based on the qualification index achieved by the VA.

For example, when the user of the electronic device 100 accesses a website (e.g., a company website) and provides the queries in a Spanish language. The qualification management engine 150 determines whether a plurality of VAs in the website supports the Spanish language or not. If one or more VAs supports the Spanish language, the qualification management engine 150 provides the qualification level (i.e., a percentage, a score, or a value and like) for each of the VAs and then, recommend those qualified VAs to the user. The qualified VAs herein is defined as VAs which accepts queries in the Spanish language.

The display controller 170 is used to display a user interface on a screen of the electronic device 100 based on the user input detected by the communication controller 190. The display of/associated with the display controller 170 can be, but not limited to, a Cathode Ray Tube (CRT), a Liquid Crystal Display (LCD), Organic Light-Emitting Diode (OLED), a Light-emitting diode (LED), Electroluminescent Displays (ELDs), field emission display (FED).

The communication controller 190 communicates with a network via conventional means such as Wi-Fi, Bluetooth, Zig-bee or any wireless communication technology and furthermore, it can also communicate internally between the various hardware components of the electronic device 100. The communication controller 190 is coupled to both the display controller 170 and the processor 110.

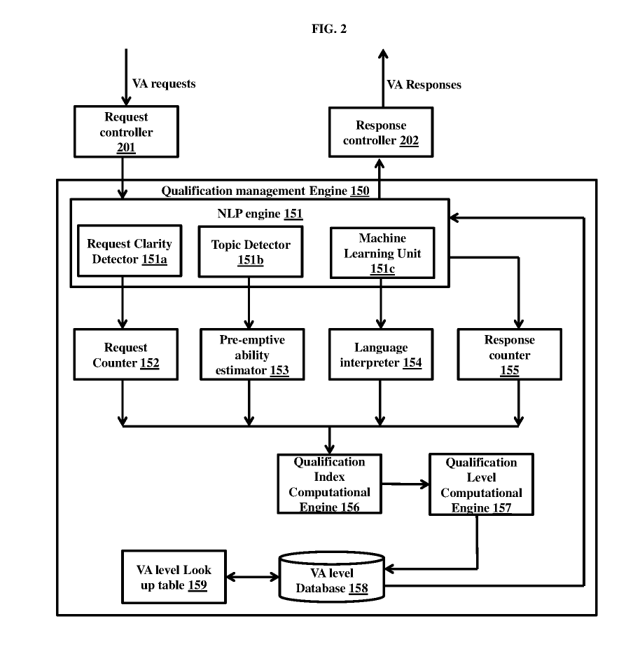

The functionality of the qualification management engine 150 is detailed in conjunction with FIG. 2, described below.

The FIG. 1 shows the various hardware components of the electronic device 100 but it is to be understood that other embodiments are not limited thereon. In other embodiments, the electronic device 100 may include less or more number of units. Further, the labels or names of the units are used only for illustrative purpose and does not limit the scope of the invention. One or more units can be combined together to perform same or substantially similar function in the electronic device 100.

FIG. 2 is a block diagram illustrating various hardware components of a qualification management engine, according to an embodiment as disclosed herein.

In FIG. 2, the qualification management engine 150 includes a Natural Language Processing (NLP) engine 151, a request counter 152, a pre-emptive ability estimator 153, a language interpreter 154, a response counter 155, a qualification index computational engine 156, a qualification level computational engine 157, a VA level database 158 and a VA level lookup table 159.

The qualification management engine 150 receives the user request via a request controller 201. The request controller 201 is configured to provide a request interface on the display screen of the electronic device 100, where the user provides the user requirements. The request interface can be, but not limited to, a query window, a dialog box which is displayed on the screen of the electronic device 100, or the like. In another embodiment, the request controller 201 can be configured to process, for e.g., voice queries, voice command, or text queries.

The NLP engine 151 can be configured to process the request received and thereafter can be configured to provide a response to the user request through a response interface associated with the response controller 202. The response interface can be, but not limited to, a query window, or a dialog box which is displayed on the screen of the electronic device. In another embodiment, the response controller 202 can be configured to process, for e.g., the voice queries, voice command, or text queries.

Further, the NLP engine 151 includes a request clarity detector 151a, a topic detector 151b and a machine learning unit 151c. The request clarity detector 151a detects whether the received user request is a clear request or an unclear request. In other words, whether the received user request is clear or unclear to the VA. For example, when the user provides queries in Spanish language, the request clarity detector 151a detects whether the queries provided in Spanish language are clear/unclear to the VA.

Further, the request counter 152 determines the ability parameter of the VA by determining the number of clear and/or the number of unclear requests of the user provided by the request clarity detector 151a.

Further, the topic detector 151b determines whether a topic of the user request is within a topic list present in the VA level database 158. The machine learning unit 151c determines the ability parameters of VA by monitoring whether the VA is the single-purpose application or the multi-purpose application, a standalone application or a networked application, and the application is whether multi-linguistic or having only one linguistic ability. For example, when the user provides queries regarding “gaming”, the topic detector 151b determines whether the topic “entertainment (gaming)” is present in the topic list or not.

The single-purpose application can be, but not limited to the VA which handles the user requests of a particular topic (e.g., finance, or travel etc.). The multi-purpose application can be, but not limited to the VA which handles the user requests of more than one topic (e.g., handling both finance and travel related queries). The standalone application can be, but not limited to VA which is not networked with other VAs. The networked application can be, but not limited to VA which is networked with other VAs.

The pre-emptive ability estimator 153 calculates the pre-emptive ability parameter of the VA based on the topic identified by the topic detector 151b. The language interpreter 154 can be configured to analyze the linguistic ability parameter of the VA e.g., whether the VA supports one or more languages.

For example, when the user provides the query in the VA, the pre-emptive ability estimator 153 determines the pre-emptive words during the query provided.

The response counter 155 increments the response count provided by the VA based on the user queries. For example, when the user provides queries to the VA, the VA provide answers based on the queries and the response counter 155 increments the response count of the VA based on the answers provided by the VA.

Further, based on the ability parameters the qualification index computational engine 156 can be configured to determine the qualification index for the VA. The qualification index can be, but not limited to a value defined in terms of score, a percentage value and like. The qualification index for the VA is calculated by aggregating all the aforementioned ability parameters of the VA.

Further, the qualification level computational engine 157 detects whether the qualification index, computed by the qualification index computational engine 156, meets a qualification criteria. The qualification criteria, for e.g., defines the qualification level indicating an ability of the VA to influence the user.

The VA level look up table 159 can be configured to monitor a reference table of VAs in VA level database 158. The reference table provide future reference of VAs having different qualification levels.

Consider an example, when the electronic device 100 receives the user requirement, via the request controller 201, to access the VA having one linguistic ability. The language interpreter 154 compares the user requirement with the plurality of VAs, where the plurality of VAs are stored in the memory 130. Further, the language interpreter 154 identifies the qualified VAs having one linguistic ability and provide a weightage (e.g., a value or a score) to the linguistic ability of each of the qualified VAs. Further, the qualification index computational engine 156 determines the qualification index for each of the qualified VAs by summing all the weightage values of each of the qualified VAs.

Further, the qualification level computational engine 157 determines the qualification level for each of the qualified VAs based on the qualification index achieved by each of the qualified VAs. The qualification level herein defined as the level which the qualified VA influence the user based on the user requirement. Further, the machine learning unit 151c ranks the qualified VAs having one linguistic ability, where the qualified VAs are ranked based on the qualification level achieved by each of the qualified VAs. Furthermore, the qualification management engine 150 recommends the ranked qualified VAs to the user via the response controller 202.

Consider another example, when the electronic device 100 receives the user requirement, via the request controller 201to access the VA which is the multi-purpose application. The machine learning unit 151c compares the user requirement with the plurality of VAs, where the plurality of VAs are stored in the memory 130. Further, machine learning unit 151c identifies the qualified VAs which are multi-purpose applications and provide the weightage (e.g., a value or a score) to the multi-purpose ability of each of the qualified VAs. Further, the qualification index computational engine 156 determines the qualification index for each of the qualified VAs by summing all the weightage values of each of the qualified VAs.

Further, the qualification level computational engine 157 determines the qualification level for each of the qualified VAs based on the qualification index achieved by each of the qualified VAs. The qualification level, herein, defines the level at which the qualified VA influences the user based on the user requirement. Further, the machine learning unit 151c ranks the qualified VAs which are multi-purpose applications, where the qualified VAs are ranked based on the qualification level achieved by each of the qualified VAs. Furthermore, the qualification management engine 150 recommends the ranked qualified VAs to the user via the response controller 202.

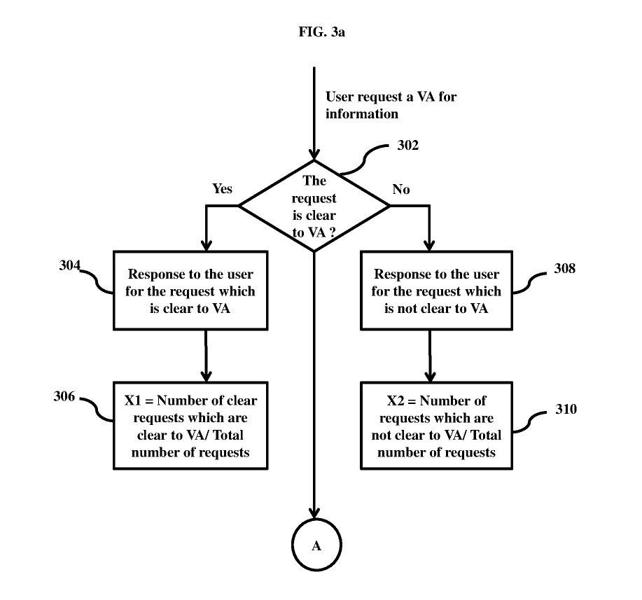

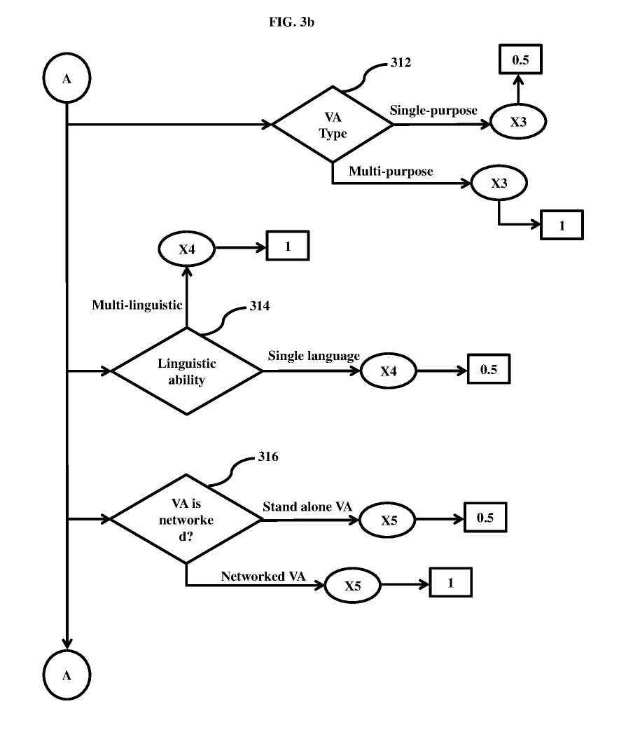

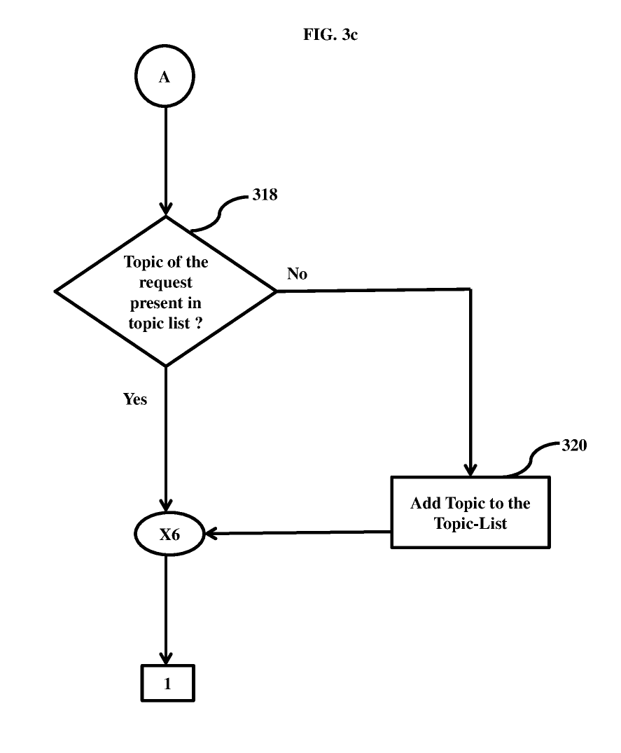

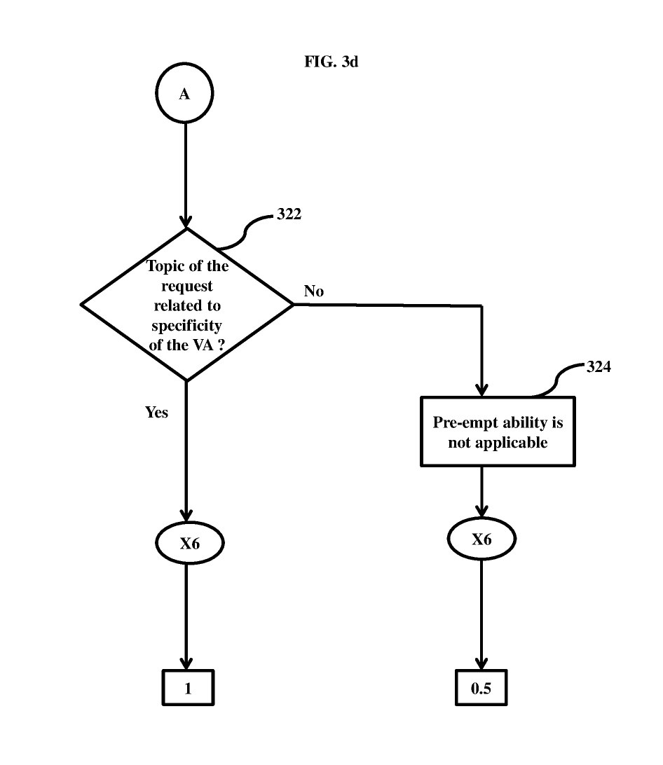

FIGS. 3A-3D is a flow chart illustrating a method to determine ability parameters of a VA, according to an embodiment as disclosed herein.

In FIG. 3A, the VA associated with the electronic device 100 receives the user request via the request controller 201. At step 302, the request clarity detector 151a determines whether the received user request is clear/unclear to the VA. If the user request is clear (i.e. Understandable) to the VA, then at step 304, the NLP engine 151 can be configured to provide the response to the user for clear requests. Further, at step 306, the qualification management engine 150 can calculate an ability parameter X1. The ability parameter X1 is the ability of the VA to understand the received request from the user.

Further, at step 302, if request clarity detector 151a detects that the user request is unclear to the VA, then the NLP engine 151, at step 308, can be configured to provide a response to the user for the number of unclear requests. Further, at step 310, the qualification management engine 150 will calculate an ability parameter X2. The ability parameter X2 is the ability of the VA which cannot understand the request from the user.

The request counter 152 calculates the ability parameters X1 by dividing the number of clear requests to the total number of requests (i.e., X1=number of clear requests/total number of requests) and similarly, the request counter 152 calculates the ability parameter X2 by dividing the number of requests which are unclear to the total number of requests (i.e., X2=number of clear requests/total number of requests).

For example, if the VA receives hundred requests form the users and the request clarity detector 151a recognizes the VA got seventy-five requests as clear request and twenty five requests as unclear request (i.e., requests which are unclear to VA), the request counter 152 calculates the ability parameter X1= 75/100 and set a value 0.75 for the VA and further, calculates the ability parameter X2= 25/100 and set a value 0.25 for the VA.

In FIG. 3B, at step 312, the machine learning unit 151c determines an ability parameter X3. The ability parameter X3 defines whether the VA is the single-purpose or the multi-purpose application. Further, machine learning unit 151c sets the ability parameter X3 to a value for the VA based on the type of the VA. For example, if the VA provides only chatting facility, the machine learning unit 151c recognizes the VA as the single-purpose application and set the ability parameter X3 to a value (e.g., 0.5) and alternatively, if the VA provides both chatting facility and media sharing facility, the machine learning unit 151c recognizes the VA as the multi-purpose application and set the ability parameter X3 to a value (e.g., 1).

At step 314, the language interpreter 154 determines an ability parameter X4. The ability parameter X4 is the linguistic ability of the VA and further, the language interpreter 154 set the ability parameter X4 to a value for the VA based on the linguistic ability of the VA. For example, if the VA supports many languages, the language interpreter 154 set the ability parameter X4 to a value (e.g., 1) and alternatively, if the VA supports only one language, the language interpreter 154 set the ability parameter X4 to a value (e.g., 0.5).

At step 316, the machine learning unit 151c determines an ability parameter X5. The ability parameter X5 defines whether the VA is networked with other VAs or not and further, the machine learning unit 151c set the ability parameter X5 to a value based on a type of the VA. For example, if the VA is networked with other VAs, the machine learning unit 151c set the ability parameter X5 to a value (e.g., 1) and alternatively, if the VA is not networked with other VAs, the qualification management engine 150 recognizes the VA is not networked with other VAs and the machine learning unit 151c set the ability parameter X5 to a value (e.g., 0.5).

The VA is networked with other VAs is defined as the VA which is communicatively coupled with one or more VAs. For example, consider a scenario which a VA-1 is communicatively coupled to other VAs such as VA-2, VA-3 and VA-4, receives the user request (i.e., queries) regarding financial payments. If the VA-1 does not have the ability to respond the user request, then the VA-1 can be configured to determine the abilities of other VAs and route the user request to other VAs which have the ability to respond to the user request. For e.g., the VA can communicate with other VAs through one or more network means (wireless, in particular but not limited thereof).

In an embodiment, the VA is networked with other VAs is defined as the VA which is communicatively coupled with one or more VAs. For example, consider a scenario which a VA-1 is communicatively coupled other VAs such as VA-2, VA-3 and VA-4, receives the user request (i.e., queries) regarding financial payments. If VA-1 does not have the ability to respond the user request regarding financial payments, the VA-1 checks the abilities of other VAs and route the user request to other VAs which have the ability to respond to the user request.

In FIG. 3C, the pre-emptive ability estimator 153 determines an ability parameter X6. The ability parameter X6 defines whether the VA is having the pre-emptive ability to pre-empt the request and further, the pre-emptive ability estimator 153 set the ability parameter X6 to a value based on the pre-emptive ability of the VA. At step 318, if the VA is the multi-purpose application, then the topic detector 151b determines whether the topic of the request is present in the topic list or not. If the topic of the request is present in the topic list, the pre-emptive ability estimator 153 sets the ability parameter X6 to a value (e.g., 1) and alternatively, if the topic detector 151b detects the topic of the request is not present in the topic list, then at step 320, the machine learning unit 151c adds the topic to the topic list and then set the ability parameter X6 to a value (e.g., 1).

For example, if the topic of the request is based on the financial payment/transactions, the pre-emptive ability estimator 153 interprets the request as the finance related request. In yet another example, if the topic of the request is based on a pizza delivery, the pre-emptive ability estimator 153 interprets the request as the food ordering request. Topic list herein is a repository of topics or nature of requests which are pre classified into different sections such as finance, travel, shopping etc.

In FIG. 3D, if the VA is single-purpose application, the topic detector 151b determines whether the topic of the request is related to a specificity of the VA at step 322. If the topic detector 151b detects the topic of the request is related to the specificity of the VA, the pre-emptive ability estimator 153 recognizes that the VA has a preemptive ability to pre-empt the request and set the ability parameter X6 to a value (e.g., 1). Alternatively, if the topic detector 151b detects the topic of the request is not related to the specificity of the VA, at step 324 the pre-emptive ability estimator 153 recognizes that that the preemptive ability to pre-empt the request is not applicable. Further, pre-emptive ability estimator 153 set the ability parameter X6 to a value (e.g., 0.5).

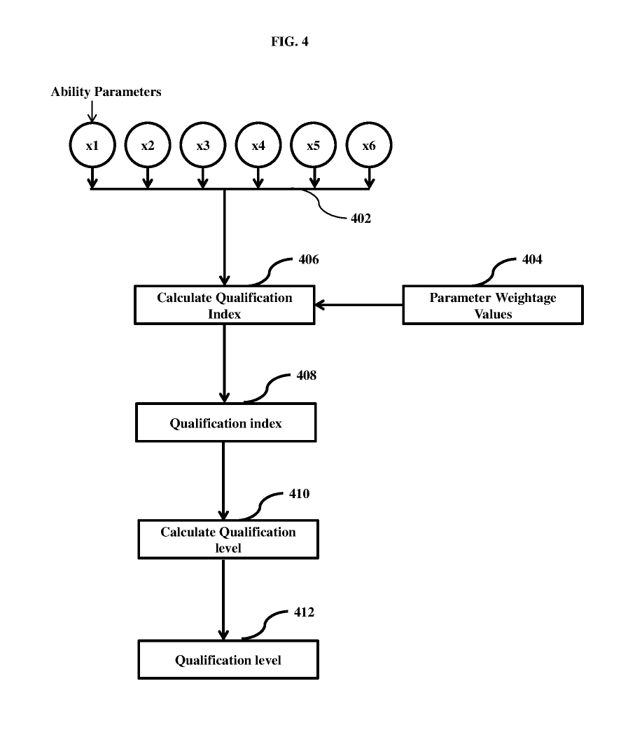

FIG. 4 illustrates a flow chart diagram to determine a qualification level for the VA based on the ability parameters associated with the VA, according to an embodiment as disclosed herein. In FIG. 4, the qualification level computational engine 157 determines a qualification level for the VA based on the ability parameters X1 to X6. At step 402, the ability parameters X1 to X6 are determined based on the method as discussed in FIGS. 3A-3D and further, at step 404, the qualification index computational engine 156 determines a weight associated with each of the ability parameters based on user preferences and user expectations. At step 406, the qualification index computational engine 156 further calculates the qualification index using the qualification index computational model 156 (shown in FIG. 2).

The qualification index computational model 156 uses both the values set by the ability parameters X1 to X6 and the weights associated with the ability parameters X1 to X6 to calculate the qualification index. The qualification index is calculated by aggregating all the values of the ability parameters and weightages to the total number of the ability parameters. The qualification index (QI) is given by QI=(A1X1+A2X2+A3X3+A4X4+A5X5+A6X6)/N=6 where, A1 to A6 is a number of VA parameter weightage values and X1 to X6 is a number of VA ability parameter values and N=6 defines number of ability parameters are 6.

For better understanding the process of evaluating the qualification indexes herein provided with the VA ability parameter values and weightage values using Table 1 and Table 2 as shown below:

Table 1 consists of sample values of ability parameters of different types of VAs.

TABLE 1

| VA | X1 | X2 | X3 | X4 | X5 | X6 |
|---|---|---|---|---|---|---|
| VA 1 | 0.4 | 0.5 | 0.6 | 1 | 0.5 | 1 |
| VA 2 | 0.5 | 0.6 | 0.3 | 0.5 | 0.5 | 0.5 |
| VA 3 | 0.5 | 0.6 | 0.3 | 0.5 | 1 | 1 |

Table 2 consists of three sets of VA parameter weightage values

TABLE 2

| Weightage | A1 | A2 | A3 | A4 | A5 | A6 |
|---|---|---|---|---|---|---|
| W1 | 0.3 | 0 | 0.3 | 0.1 | 0.2 | 0.1 |
| W2 | 0.4 | 0.1 | 0.1 | 0.2 | 0.1 | 0.1 |
| W3 | 0.1 | 0.2 | 0.3 | 0.4 | 0 | 0 |

Table 3 represents the evaluation to be followed for finding the VA qualification index of three different VAs such as VA1, VA2, VA3

TABLE 3

| VA | | | |
|---|---|---|---|
| qualification | | | |
| Index | I1 | I2 | I3 |
| VA 1 | VA 1 × W1 | VA 1 × W 2 | VA 1 × W 3 |
| VA 2 | VA 2 × W 1 | VA 2 × W 2 | VA 2 × W 3 |
| VA 3 | VA 3 × W 1 | VA 3 × W 2 | VA 3 × W 3 |

Table 4, Table 5 and Table 6 represents the calculated values based on VA qualification index expression and Table 3.

TABLE 4

| | | | | | | | A1X1 + | I = (A1X1 + |
|---|---|---|---|---|---|---|---|---|
| | | | | | | | A2X2 + | A2X2 + |
| | | | | | | | A3X3 + | A3X3 + |
| | | | | | | | A4X4 + | A4X4 + |
| | | | | | | | A5X5 + | A5X5 + |
| VA 1 | A1X1 | A2X2 | A3X3 | A4X4 | A5X5 | A6X6 | A6X6 | A6X6)/N |
| VA 1 x | 0.12 | 0 | 0.18 | 0.1 | 0.1 | 0.1 | 0.6 | 0.100 |
| W1 | | | | | | | | |
| VA 1 x W | 0.16 | 0.05 | 0.06 | 0.2 | 0.05 | 0.1 | 0.62 | 0.103 |
| 2 | | | | | | | | |
| VA 1 x W | 0.04 | 0.1 | 0.18 | 0.4 | 0 | 0 | 0.72 | 0.120 |
| 3 | | | | | | | | |

TABLE 5

| | | | | | | | A1x1 + | I = (A1X1 + |
|---|---|---|---|---|---|---|---|---|
| | | | | | | | A2x2 + | A2X2 + |
| | | | | | | | A3x3 + | A3X3 + |
| | | | | | | | A4x4 + | A4X4 + |
| | | | | | | | A5x5 + | A5X5 + |
| VA 2 | A1X1 | A2X2 | A3X3 | A4X4 | A5X5 | A6X6 | A6x6 | A6X6)/N |
| VA 2 x | 0.15 | 0 | 0.09 | 0.05 | 0.1 | 0.05 | 0.44 | 0.073 |
| W1 | | | | | | | | |
| VA 2 x W | 0.2 | 0.06 | 0.03 | 0.1 | 0.05 | 0.05 | 0.49 | 0.082 |
| 2 | | | | | | | | |
| VA 2 x W | 0.05 | 0.12 | 0.09 | 0.2 | 0 | 0 | 0.46 | 0.077 |
| 3 | | | | | | | | |

TABLE 6

| | | | | | | | A1X1 + | I = (A1X1 + |
|---|---|---|---|---|---|---|---|---|
| | | | | | | | A2X2 + | A2X2 + |
| | | | | | | | A3X3 + | A3X3 + |
| | | | | | | | A4X4 + | A4X4 + |
| | | | | | | | A5x5 + | A5X5 + |
| VA 3 | A1X1 | A2X2 | A3X3 | A4X4 | A5X5 | A6X6 | A6X6 | A6X6)/N |
| VA 3 x W1 | 0.15 | 0 | 0.09 | 0.05 | 0.2 | 0.1 | 0.59 | 0.098 |
| VA 3 x W | 0.2 | 0.06 | 0.03 | 0.1 | 0.1 | 0.1 | 0.59 | 0.098 |
| 2 | | | | | | | | |
| VA 3 x W | 0.05 | 0.12 | 0.09 | 0.2 | 0 | 0 | 0.46 | 0.076 |
| 3 | | | | | | | | |

Table 7 below represents the final evaluated qualification index of three different VAs such as VA 1, VA 2, VA 3 based on the sample data sets of VA parameter values and weightage values mentioned in Table 1 & Table 2.

| VA | | | |
|---|---|---|---|
| qualification | Qualification | Qualification | Qualification |
| Index | Index (1) | Index (2) | Index (3) |
| VA 1 | 0.100 | 0.103 | 0.120 |
| VA 2 | 0.073 | 0.082 | 0.077 |
| VA 3 | 0.098 | 0.098 | 0.077 |

Further, at step 410, the qualification level computational engine 157, calculates the qualification level for the VA by detecting whether the qualification index meets a qualification criteria, where the qualification criteria defines a qualification level indicating an ability of a VA to meet the user requirement and the user preferences.

For better understanding the tables 8, 9, and 10 represents the qualification level for the three different VAs based on the sample qualification criteria and the qualification index as shown in the Table 7.

TABLE 8

| Virtual | Qualification Index | Qualification | |
|---|---|---|---|
| Assistant | (1) | Criteria | Qualification Level |
| VA-1 | 0.100 | 0.1-0.5 | Level-II |
| VA-2 | 0.073 | 0-0.1 | Level-I |
| VA-3 | 0.098 | 0-0.1 | Level-I |

TABLE 9

| Virtual | Qualification Index | Qualification | |
|---|---|---|---|
| Assistant | (1) | Criteria | Qualification Level |
| VA-1 | 0.103 | 0.1-0.5 | Level-II |
| VA-2 | 0.082 | 0-0.1 | Level-I |
| VA-3 | 0.098 | 0-0.1 | Level-I |

TABLE 10

| Virtual | Qualification Index | Qualification | |
|---|---|---|---|
| Assistant | (1) | Criteria | Qualification Level |
| VA-1 | 0.120 | 0.1-0.5 | Level-II |
| VA-2 | 0.077 | 0-0.1 | Level-I |
| VA-3 | 0.077 | 0-0.1 | Level-I |

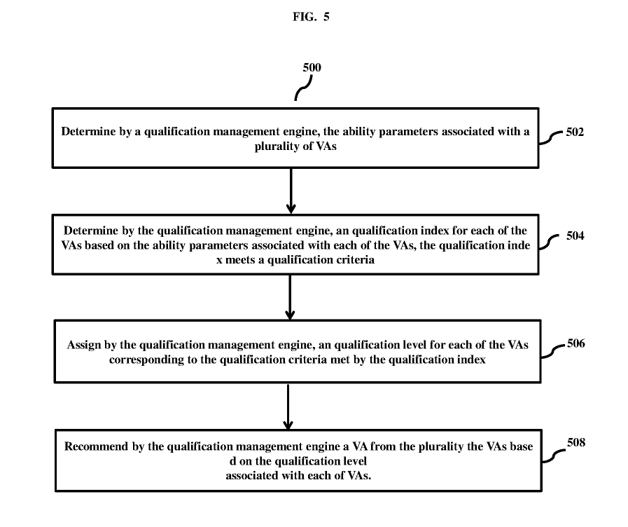

FIG. 5 is a flow diagram 500 of a method to recommend the VA to a user based on a qualification level of a VA, according to an embodiment as disclosed herein.

At 502, the method includes determining the ability parameters associated with the plurality of VAs. In an embodiment, the method allows the qualification management engine 150 to determine the ability parameters associated with the plurality of VAs.

At 504, the method includes determining the qualification index for each of the VAs based on the ability parameters associated with each of the VAs, where the qualification index meets the qualification criteria. In an embodiment, the method allows the qualification index computational engine 156 to determine the qualification index for each of the VAs based on the ability parameters associated with each of the VAs, where the qualification index meets the qualification criteria.

At 506, the method includes assigning the qualification level for each of the VAs corresponding to the qualification criteria met by the qualification index. In an embodiment, the method allows the qualification level computational engine 157 to assign the qualification level for each of the VAs corresponding to the qualification criteria met by the qualification index.

At 508, the method includes recommending the VA from the plurality the VAs based on the qualification level associated with each of VAs. In an embodiment, the method allows the qualification management engine 150 to recommend the VA from the plurality of VAs based on the qualification level associated with each of the VAs.

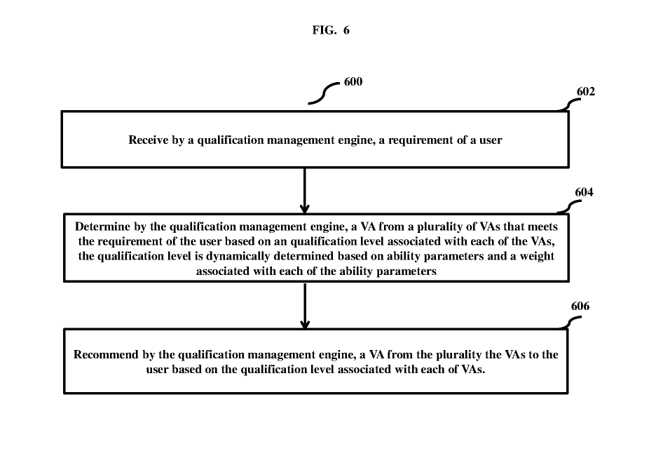

FIG. 6 is a flow diagram 600 illustrating a method to recommend the VA to a user based on a requirement of the user, according to an embodiment as disclosed herein.

At 602, the method includes receiving a requirement of the user. In an embodiment, the method allows the qualification management engine 150 to receive the requirement of the user.

At 604, the method includes determining the VA from a plurality of VAs that meets the requirement of the user based on the qualification level associated with each of the VAs, where the qualification level is dynamically determined based on the ability parameters and the weight associated with each of the ability parameters. In an embodiment, the method allows the qualification level computational engine 157 to assign the qualification level associated with each of the VAs based on the the ability parameters and the weight associated with each of the ability parameters.

At 606, the method includes recommending the VA from the plurality the VAs to the user based on the qualification level associated with each of VAs. In an embodiment, the method includes the qualification management engine 150 to recommend the VA from the plurality the VAs to the user based on the qualification level associated with each of VAs.

The embodiments disclosed herein can be implemented through at least one software program running on at least one hardware device and performing network management functions to control the elements. The elements shown in the FIGS. 1 through 6 include blocks which can be at least one of a hardware device, or a combination of hardware device and software module.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for managing virtual assistants (VAs), the method comprising:
determining, by a qualification management engine, ability parameters associated with a plurality of VAs;
determining, by the qualification management engine, a qualification level for each of the VAs based on the ability parameters associated with each of the VAs, wherein the qualification level indicates an ability of the VA to meet a user requirement; and
recommending, by the qualification management engine, at least one VA from the plurality of the VAs based on the qualification level associated with each of the VAs.

2. The method of claim 1, wherein the ability parameters comprises a number of clear user request received at the VA, a number of unclear user requests received at the VA, a pre-emptive ability of the VA to pre-empt a user request, a type of the VA and a linguistic ability of the VA.

3. The method of claim 2, wherein the pre-emptive ability of the VA to pre-empt the user request is determined by:
determining a type of the VA;
detecting whether the VA is one of a single-purpose application and a multi-purpose application based on the type of the VA; and
determining the VA ability to pre-empt the user request based on one of the single-purpose application and the multi-purpose application.

4. The method of claim 1, wherein each of the ability parameters is associated with a weight dynamically determined based on at least one of user preferences and user expectations from the VA.

5. The method of claim 1, wherein determining, by the qualification management engine, a qualification level for each of the VAs based on the ability parameters associated with each of the VAs comprising:
determining a qualification index for each of the VAs based on the ability parameters associated with each of the VAs, wherein the ability parameters are dynamically determined based on a user interaction with the VAs in real-time;
detecting whether the qualification index meets at least one qualification criteria, wherein the qualification criteria defines a qualification level indicating an ability of a VA to meet a user requirement; and
assigning the qualification level corresponding to the qualification criteria.

6. The method of claim 1, wherein recommending, by the qualification management engine, the at least one VA from the plurality of the VAs based on the qualification level associated with each of VAs comprising:
receiving, by the qualification management engine, a requirement of a user;
dynamically determining, by the qualification management engine, the at least one VA from a plurality of VAs that meets the requirements of the user based on the qualification level associated with each of the VAs; and
recommending, by the qualification management engine, the at least one VA to the user, wherein the at least one recommended VA is ranked based on the qualification level.

7. A method for managing virtual assistants, the method comprising:
receiving, by a qualification management engine, a requirement of a user;
dynamically determining, by the qualification management engine, at least one VA from a plurality of VAs that meets the requirement of the user based on a qualification level associated with each of the VAs, wherein the qualification level is dynamically determined based on ability parameters and a weight associated with each of the ability parameters; and
recommending, by the qualification management engine, the at least one virtual assistant to the user.

8. The method of claim 7, wherein the qualification level indicates an ability of the virtual assistant to influence the user.

9. The method of claim 7, wherein the ability parameters comprises a number of clear user request received at the VA, a number of unclear user requests received at the VA, a pre-emptive ability of the VA to pre-empt a user request, a type of the VA and a linguistic ability of the VA.

10. The method of claim 7, wherein the qualification level for each of the virtual applications is dynamically determined by:
determining, by the qualification management engine, a plurality of parameters associated with each of the VAs;
determining a qualification index for each of the VAs based on the ability parameters associated with each of the VAs, wherein the ability parameters are dynamically determined based on a user interaction with the VAs in real-time;
detecting whether the qualification index meets at least one qualification criteria, wherein the qualification criteria defines a qualification level indicating an ability of a VA to meet a user requirement; and
assigning the qualification level corresponding to the qualification criteria.

11. The method of claim 9, wherein the pre-emptive ability to pre-empt the user request is determined by:
determining a type of a VA;
detecting whether the VA is one of a single-purpose application and a multi-purpose application based the type of the VA; and
determining the VA ability to pre-empt the user request based on one of the single-purpose application and the multi-purpose application.

12. The method of claim 7, wherein the weight associated with each of the ability parameters is dynamically determined based on at least one of user preferences and user expectations from the virtual assistant.

13. An electronic device for managing virtual assistants, the electronic device comprising:
a display controller;
a memory to store a plurality of VAs;
a processor; and
a qualification management engine, operably coupled to the processor and the memory, configured to:
determine the ability parameters associated with a plurality of VAs,
determine a qualification level for each of the VAs based on the ability parameters associated with each of the VAs, wherein the qualification level indicates an ability of the VA to meet a user requirement, and
recommend at least one VA from the plurality of the VAs based on the qualification level associated with each of VAs.

14. The electronic device of claim 13, wherein the ability parameters comprises a number of clear user request received at the VA, a number of unclear user requests received at the VA, a pre-emptive ability of the VA to pre-empt a user request, a type of the VA and a linguistic ability of the VA.

15. The electronic device of claim 14, wherein the pre-emptive ability of the VA to pre-empt the user request is determined by:
determining a type of the VA;
detecting whether the VA is one of a single-purpose application and a multi-purpose application based on the type of the VA; and
determining the VA ability to pre-empt the user request based on one of the single-purpose application and the multi-purpose application.

16. The electronic device of claim 13, wherein each of the ability parameters is associated with a weight dynamically determined based on at least one of user preferences and user expectations from the VA.

17. The electronic device of claim 13, wherein the qualification management engine determines the qualification level for each of the VAs based on the ability parameters associated with each of the VAs comprising:
determine a qualification index for each of the VAs based on the ability parameters associated with each of the VAs, wherein the ability parameters are dynamically determined based on a user interaction with the VAs in real-time;
detect whether qualification index meets at least one qualification criteria, wherein the qualification criteria defines a qualification level indicating an ability of a VA to meet a user requirement; and
assign the qualification level corresponding to the qualification criteria.

18. The electronic device of claim 13, wherein the qualification management engine determines the at least one VA from the plurality of the VAs based on the qualification level associated with each of VAs comprising:
receive a requirement of a user;
dynamically determine the at least one VA from a plurality of VAs that meets the requirements of the user based on the qualification level associated with each of the VAs; and
recommend the at least one VA to the user, wherein the at least one recommended is ranked based on the qualification level.

19. An electronic device for managing virtual assistants, the method comprising:
a display controller;
a memory to store a plurality of VAs;
a processor; and
a qualification management engine, operably coupled to the processor and the memory, configured to:
receive a requirement of a user,
dynamically determine at least one VA from a plurality of VAs that meets the requirement of the user based on a qualification level associated with each of the VAs, wherein the qualification level is dynamically determined based on ability parameters and a weight associated with each of the ability parameters, and
recommend the at least one virtual assistant to the user.

20. The electronic device of claim 19, wherein the qualification level indicates an ability of the virtual assistant to influence the user.

21. The electronic device of claim 19, wherein the ability parameters comprises a number of clear user request received at the VA, a number of unclear user requests received at the VA, a pre-emptive ability of the VA to pre-empt a user request, a type of the VA and a linguistic ability of the VA.

22. The electronic device of claim 19, wherein the qualification level for each of the virtual applications is dynamically determined by:
determine a plurality of parameters associated with each of the VAs;
determine a qualification index for each of the VAs based on the ability parameters associated with each of the VAs, wherein the ability parameters are dynamically determined based on a user interaction with the VAs in real-time;
detect whether the qualification index meets at least one qualification criteria, wherein the qualification criteria defines a qualification level indicating an ability of a VA to meet a user requirement; and
assign the qualification level corresponding to the qualification criteria.

23. The electronic device of claim 21, wherein the pre-emptive ability to pre-empt the user request is determined by:
determine a type of a VA;
detect whether the VA is one of a single-purpose application and a multi-purpose application based the type of the VA; and
determine the VA ability to pre-empt the user request based on one of the single-purpose application and the multi-purpose application.

24. The electronic device of claim 19, wherein the weight associated with each of the ability parameters is dynamically determined based on at least one of user preferences and user expectations from the virtual assistant.
